(19) United States
(12) Patent Application Publication
(10) Pub. No.: US 2022/0090858 A1
(43) Pub. Date: Mar. 24, 2022

(54) METHOD AND DEVICE FOR DRYING A FILM MATERIAL

(71) Applicant: VOLKSWAGEN AKTIENGESELLSCHAFT, Wolfsburg (DE)

(72) Inventors: Vedran GLAVAS, Wolfsburg (DE); Marco WIETHOP, Wolfenbuttel (DE); Stephane Brice Olouou GUIFO, Wolfsburg (DE); Julian KOOPMANN, Braunschweig (DE); Julian WEGENER, Wolfsburg (DE); Jonathan MUELLER, Gifhorn (DE)

(21) Appl. No.: 17/476,515

(22) Filed: Sep. 16, 2021

(30) Foreign Application Priority Data
Sep. 21, 2020 (DE) 10 2020 124 517.3

(51) Int. Cl. F26B 3/347; H01M 10/0525; H01M 4/04; F26B 23/04

(52) U.S. Cl. CPC F26B 3/347; H01M 10/0525; H01M 2220/20; F26B 23/04; H01M 4/0471

(57) ABSTRACT

A method and device for drying a foil material having a strip-shaped carrier material with a coating arranged thereon, the coating having electrically conductive constituents. The device has at least one inductor for drying the coating at least by way of electromagnetic induction.

### PRIORITY CLAIM

This patent application claims priority to German Patent Application No. 10 2020 124 517.3, filed 21 Sep. 2020, the disclosure of which is incorporated herein by reference in its entirety.

### SUMMARY

Illustrative embodiments relate to a method and a device for drying a foil material. The foil material comprises a strip-shaped carrier material with at least one coating arranged thereon, the coating having, at least in part, electrically conductive constituents.

### BRIEF DESCRIPTION OF THE DRAWINGS

Disclosed embodiments are explained in more detail below with reference to the figures. Attention should be drawn to the fact that the disclosure should not be restricted by the present exemplary embodiments. In particular, provided not explicitly presented differently, it is also possible to extract partial circumstances explained in the figures and combine these with other constituent parts. Reference should be made to the fact that the figures and the illustrated ratios are only schematic. In the drawings:

FIG. 1 shows a first exemplary embodiment of a known device;

FIG. 2 shows a second exemplary embodiment of a known device;

FIG. 3 shows a device;

FIG. 4 shows a first exemplary embodiment of an inductor in a perspective view;

FIG. 5 shows a second exemplary embodiment of an inductor in a perspective view; and

FIG. 6 shows a third exemplary embodiment of an inductor in a perspective view.

### DETAILED DESCRIPTION

Batteries, in particular, lithium-ion batteries, find increasing use in driving transportation vehicles. Batteries are usually assembled from cells, with each cell having a stack of anode-, cathode- and separator sheets. At least some of the anode- and cathode sheets are embodied as a current collector for conducting the current provided by the cell to a load arranged outside of the cell.

During the production of a lithium-ion battery cell, a so-called carrier foil, i.e., a strip-shaped carrier material, is coated on both sides with a slurry by way of an application tool. The slurry consists of a plurality of components, inter alia an active material, conductive carbon black, binders, solvents and optionally other additives. Following the coating, the foil is fed to a drying process to evaporate the solvent contained therein and to securely connect the remaining constituents to the carrier foil. The carrier foil forms a current collector of the battery cell. In this case, the coating may be applied to both sides and subsequently dried at the same time or the coating may be applied to one side and individually dried in each case.

As a rule, the dryer is a continuous floating web dryer and is several meters long. The foil material is “levitated” by air nozzles that are directed from bottom to top and exposed to the warm/hot atmosphere of the oven, as a result of which the slurry dries. To facilitate good drying, the oven can be divided into a plurality of zones at different temperatures. As a result of the type of oven, drying is very inefficient and consumes large amounts of energy during the production of a battery cell. Moreover, the temperature in the dryer can only be controlled in the strip direction, i.e., the conveying direction of the foil material, by way of different heating zones. There cannot be a targeted temperature gradient transversely to the strip direction. A further problem is found in the alignment of the conductive carbon black, the particles or fibers that form the conductive carbon black ensuring an electron transport of active material particles to the carrier material, i.e., to the conductor foil. To design this transport to be as efficient as possible, the conductive carbon black fibers should be oriented as perpendicular as possible with respect to the carrier material. An alignment of the particles in the electrode layer can be accompanied by positive properties, even in the case of non-spherical active material particles. However, this is not possible in the case of current oven concepts.

A conventional floating web continuous oven or dryer has the following drawbacks:
great power demands;
indirect heating of the foil material;
limited speed of the electrodes passing through the oven;
a targeted alignment of slurry constituents is not possible during drying;
complicated and energy-intensive floating technology for the carrier foils.

U.S. Pat. No. 9,077,000 B2 has disclosed a method for treating conductor foils with heat. These are heated either in an oven as a whole or optionally only locally by way of a laser beam.

Disclosed embodiments at least partly solve the problems listed in relation to the prior art. The intention is to propose a method and a device for drying a foil material, the method and the device having lower power demands and facilitating targeted heating of certain regions of the foil material, a more accurate temperature control and a targeted alignment of slurry constituents.

A method having the features according to Patent claim 1 and a device having the features according to Patent claim 12 contribute to achieving these purposes. The features listed individually in the patent claims are able to be combined with one another in technologically expediency and can be complemented by explanatory circumstances from the description and/or by details from the figures, wherein further exemplary embodiments are highlighted.

A method for drying a foil material is proposed, the foil material comprising a strip-shaped carrier material with at least one coating arranged thereon. The coating has electrically conductive constituents. The method includes at least the following:

a) providing the foil material;

b) providing a device for drying the coating, the device having at least one inductor;

c) drying the coating at least by way of electromagnetic induction.

The strip-shaped carrier material consists of at least partly electrically conductive material.

Strip-shaped means that the carrier material has a great length, in particular, a substantially endless length, extending in a conveying direction, a smaller width extending transversely thereto and an even smaller thickness extending transversely to the length and the width. Width and thickness are constant in each case.

The carrier material is coated before implementation of the method.

A relative movement is also generated between the foil material and the device in a third operation of the disclosed method.

The carrier material is moved in a conveying direction relative to the device for drying and is coated with the coating prior to the entry, in particular, immediately prior to the entry, into the device.

The foil material can be coated only on one side or on a first side and an opposite second side, which are defined by the length and the width.

According to the third operation of the method, the foil material can be transported or conveyed through the device in a conveying direction in relation to surroundings and the device. As an alternative or in addition thereto, the at least one inductor can carry out a relative movement in relation to the foil material or in relation to the surroundings.

The relative movement between foil material and device can be discontinuous, but can also be continuous.

Drying by using inductive heating of the foil material, i.e., the carrier material and the slurry, is proposed.

The carrier material and the slurry arranged thereon can be tensioned by a tension roller located upstream of the coating and a tension roller located downstream of the device. The slurry can be applied to the carrier material on both sides. Then, the foil material runs past the at least one inductor, or is moved relative thereto, for example, along the conveying direction, wherein the movement can be discontinuous or continuous.

The at least one inductor induces a first alternating electromagnetic field in the carrier material and the electrically conductive constituents of the slurry. As a result, the slurry and carrier material are heated directly. The desired temperature or temperature profile (e.g., along the depth of the foil material) can be adapted by the parameters of the at least one inductor, e.g., electric current or frequency.

The foil material is conveyed at least in one conveying direction through the device and, in the process, dried by at least one first alternating electromagnetic field. The foil material is conveyed contactlessly through the device at least by a gas flow or by a second alternating electromagnetic field.

The foil material can be heated by the at least one induced first alternating electromagnetic field and can be levitated by an additional second alternating electromagnetic field, which is inverted to the first alternating field, so that the foil material can be conveyed through the device contactlessly. The use of a gas flow or tension rollers can optionally be dispensed with.

The at least one inductor is arranged only on one side or on a first side and an opposite second side of the foil material.

The at least one inductor can be used in different forms, for example, as a flat coil, coil or single turn.

The at least one inductor can be embodied as a so-called longitudinal field inductor. Here, the inductor or the coil turns of the inductor extend(s) around the foil material, each coil turn extending transversely to the conveying direction. The alternating field generated thus extends substantially parallel to the conveying direction on each side of the foil material.

The at least one inductor can be embodied as a so-called transverse field inductor. Here, the inductor or the coil turns of the inductor extend(s) on both sides of the foil material, each coil turn extending over the foil material along the width of the foil material, i.e., transversely to the conveying direction. The alternating field generated thus extends through the foil material along the thickness of the foil material.

The at least one inductor can be embodied as a so-called surface inductor. Here, the inductor or a turn extends in a meandering state on one side of the foil material, in each case over the foil material along the width of the foil material, i.e., transversely to the conveying direction. The alternating field generated thus in each case extends transversely to the extent of the turn on each side of the foil material.

Other designs of the at least one inductor can also be provided. Different designs can also be combined and/or use can be made of a plurality of inductors with the same or different configuration.

The at least one inductor is operated such that the coating and the carrier material are heated differently from one another. Depending on the set process parameters, the heating may also occur more in the slurry or in the carrier material.

The foil material is conveyed at least in one conveying direction through the device and the at least one inductor is used to generate a temperature gradient in the foil material in a first direction extending transversely to the conveying direction. A temperature gradient in the foil material can also be generated in the conveying direction. In particular, different temperatures can be generated in the foil material along the width of the foil material.

It is possible to generate a temperature gradient in the conveying direction, in particular transversely to the conveying direction or combination of both, by segmenting the at least one inductor or a plurality of inductors and by control with different parameters.

The device comprises a plurality of inductors which are operable independently of one another such that temperature fields that differ from one another are generated.

It is possible to generate different temperature fields by way of inductors that are operated independently of one another or arranged separately from one another in the conveying direction.

In particular, tears and/or pores can be generable in the coating by way of a controlled heating of the coating, the tears and/or pores starting from a surface of the coating and at least extending to the carrier material. A targeted adaptation of a temperature field can be used to, e.g., introduce tears and/or pores into the electrode material or the coating in a targeted manner at some points of the foil material such that the electrolyte of the battery cell can penetrate deeper into the electrode material or into the coating.

At least some of the constituents of the coating are magnetized by the at least one inductor. These magnetized constituents can be demagnetized again by an undirected third alternating electromagnetic field that is disposed downstream in a conveying direction. The ferromagnetic constituents of the active material of the coating, for example, can be magnetized by the induced alternating electromagnetic fields. The ferromagnetic constituents can be demagnetized again by way of an undirected third alternating electromagnetic field at the end of the drying or the device.

An extractor is arranged above the at least one inductor as a constituent part of the device and can be used to extract solvent vapors emerging from the coating as a consequence of the heating.

The use of inductors is less energy intensive in relation to the known floating web ovens. Moreover, a temperature field can be adapted in a more targeted manner. The heat induced by the respective first alternating field can also be generated directly in particles or constituent parts of the coating or the slurry and so faster heating can be achieved than in the case of conventional ovens. Thus, in contrast to known ovens there is no convective heat transition from a heating gas to the foil material; instead, the heat is generated directly in the foil material.

Moreover, the respective alternating field can be adapted by way of a geometry of the at least one inductor, the arrangement thereof and the parameterization thereof. This allows the alignment of the particles or constituents of the slurry to be manipulated. By way of example, an arrangement of conductive carbon black fibers aligned perpendicular to the carrier material can be produced in a targeted manner.

The carrier material is an electrically conductive conductor foil and the coating is a slurry, wherein the slurry comprises at least an active material, a conductive carbon black, a binder and a solvent. The coating can optionally comprise further additives.

The at least one inductor brings about a targeted spatial alignment of the conductive carbon black present in the slurry as particles or fibers.

The method is able to be carried out by a controller, which is equipped, configured or programmed to carry out the above-described method. Using the controller, it is possible at least
to set a feed velocity of the foil material, for example, it is also possible to set a continuous feed or discontinuous feed; and/or
to generate an alternating field or all alternating fields, optionally operated independently of one another; and/or
to control the application of the slurry on the carrier material; and/or
to operate an extraction; and/or
to regulate a gas flow for conveying the foil material through the device contactlessly.

A device is proposed which has a suitable configuration to allow the above-described method to be performed therewith.

The device facilitates a drying of a foil material which comprises a strip-shaped carrier material with a coating arranged thereon, the coating having, at least in part, electrically conductive constituents. The device has at least one inductor for drying the coating at least by way of electromagnetic induction.

The device generates a relative movement between the foil material and the device or the at least one inductor.

The device comprises the above-described controller.

Further, the device can comprise a provision for the foil material, additionally optional tension rollers for tensioning the foil material, and/or an apparatus for applying the coating to the carrier material, and/or an extractor, and/or a rolling device for rolling up the fully dried foil material.

Further, the method can also be carried out by computer or using a processor of a control unit.

Accordingly, a system for data processing is also proposed, the latter comprising a processor which is adapted/configured such that it carries out the method or some of the operations, in particular the third operation of the proposed method.

A computer-readable storage medium can be provided, the latter comprising commands which, when executed by a computer/processor, prompt the latter to carry out the method or at least some of the operations, in particular the third operation of the proposed method.

The explanations relating to the method are transferable to the device, the controller and to the computer implemented method (i.e., the computer or the processor, the system for data processing, the computer readable storage medium), and vice versa.

The use of indefinite articles (“a”, “an”), particularly in the patent claims and the description that elucidates them, should be understood as such and not construed to mean “one”. Terms or components accordingly introduced therewith should therefore be understood as being present at least once and, in particular, also being able to be present multiple times as well.

By way of precaution, it is observed that the quantifiers (“first”, “second”, . . . ) used here predominantly serve (only) to distinguish between a plurality of similar objects, variables or processes; that is to say these do not necessarily prescribe a dependence and/or sequence of these objects, variables or processes. Any necessary dependence and/or sequence will be explicitly stated here or would be obvious to a person skilled in the art when studying the specifically described configuration. To the extent a component may be present multiple times (“at least one”), the description of one of these components may equally apply to all or some of the plurality of these components; however, this is not mandatory.

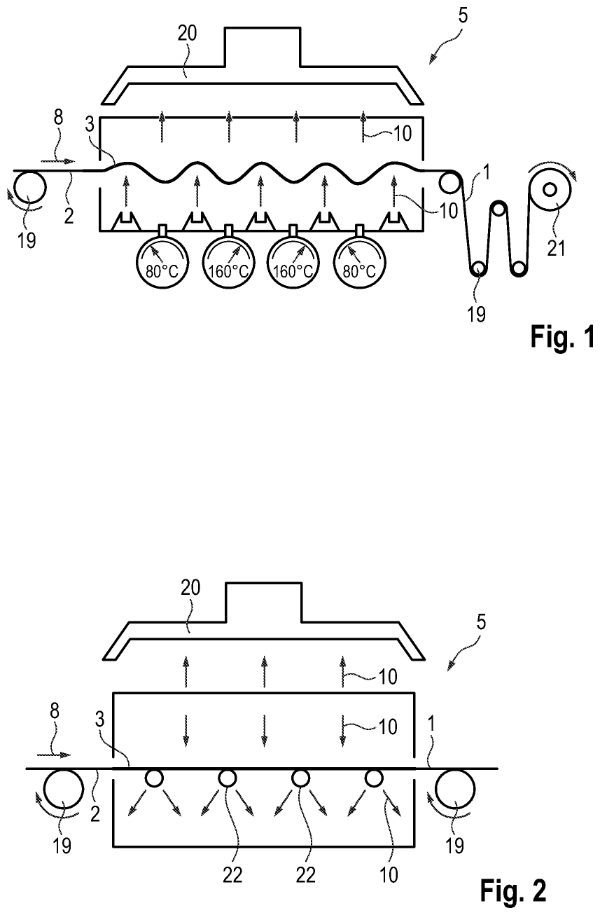

FIG. 1 shows a first disclosed embodiment of a known device 5. Here, the device 5 for drying is embodied as a continuous floating web dryer and is several meters long. The foil material 1 is introduced into the device from the left and is conveyed through the oven in the conveying direction 8. The foil material 1 is “levitated” by a gas flow 10 by air nozzles that are directed from bottom to top and exposed to the warm/hot atmosphere of the oven, as a result of which the slurry, i.e., the coating 3 arranged on the carrier material 2, dries. An extractor 20 is arranged above the foil material 1 and it can be used to remove solvents that emerge from the coating 3 during the drying process. After the oven, the foil material 1 with the dried coating 3 runs over tension rollers 19 and can continue to cool down. A rolling device 21 serves to roll up the fully dried foil material 1.

FIG. 2 shows a second disclosed embodiment of a known device 5. Reference is made to the explanations relating to FIG. 1.

In contrast to the first disclosed embodiment, guide roles 22 are provided for supporting the foil material. Negative pressure is set below the guide rolls 22 and the foil material 1 such that the coating is dried by way of a gas flow 10 that flows from top to bottom and, in the process, it is ensured that the foil material 1 rests on the guide rolls 22.

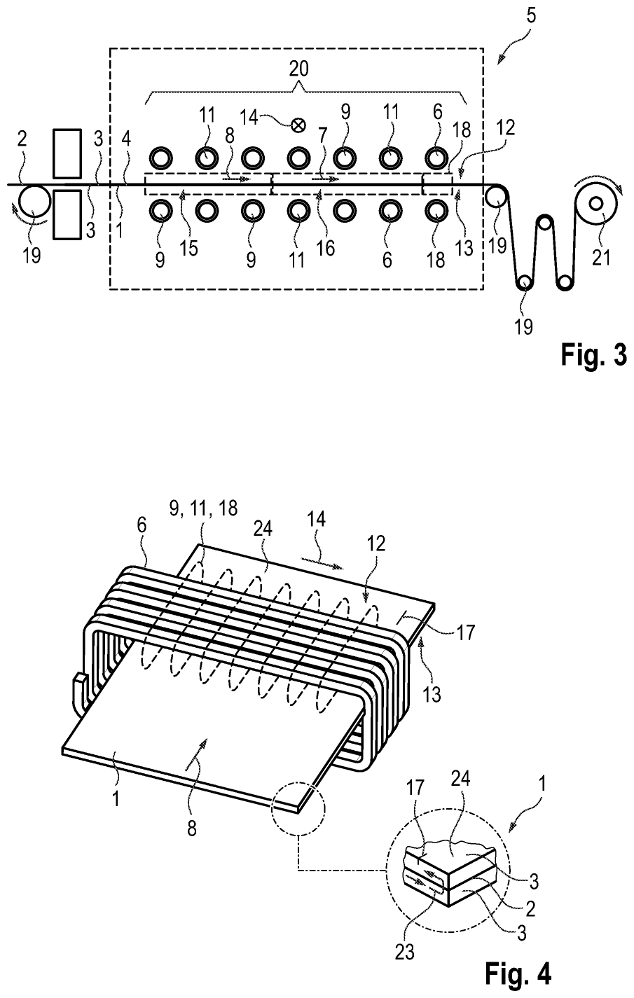

FIG. 3 shows a device 5. Reference is made to the explanations relating to FIGS. 1 and 2.

The device 5 facilitates the generation of a relative movement 7 between the foil material 1 and the device 5 and facilitates drying of the coating 3 by way of electromagnetic induction. The controller is not illustrated here. To control the relevant components, the controller can be connected thereto or communicate therewith in a known manner.

The device 5 comprises a provision of the foil material 1, an apparatus for applying the coating 3 to the carrier material 2, tension rollers 19 for tensioning the foil material 1, a plurality of inductors 6 for generating alternating fields 9, 11, 18, an extractor 20 for extracting the solvent released from the coating 3 during the drying process, tension rollers 19 for setting up a cooling path for the foil material 1, and a rolling device 21 for rolling up the fully dried foil material 1.

According to the first operation of the method, the foil material 1 is provided. Before the first operation of the method, the carrier material 2 is provided and the carrier material 2 is coated with the slurry that forms the coating 3 and has electrically conductive constituents 4. According to the second operation of the method, a device 5 for drying the coating 4 is provided, wherein the device 5 has a plurality of inductors 6; according to the third operation of the method, a relative movement 7 is generated between the foil material 1 and the device 5 and the coating 3 is dried by way of electromagnetic induction.

The strip-shaped carrier material 2 consists of electrically conductive material. The carrier material 2 has a great length, in particular, a substantially endless length, extending in the conveying direction 8, a smaller width extending transversely thereto and an even smaller thickness extending transversely to the length and the width.

According to the third operation of the method, the foil material 1 is transported or conveyed through the device 5 in a conveying direction 8 in relation to surroundings and the device 5. In this case, the inductors 6 are stationarily arranged.

The carrier material 2 and the slurry arranged thereon are tensioned by a tension roller 19 located upstream of the coating and a tension roller 19 located downstream of the device. After the application of the coating 3, the foil material 1 runs past the inductors 6 in the conveying direction 8. The inductors 6 induce a first alternating electromagnetic field 9 in the carrier material 2 and the electrically conductive constituents 4 of the slurry. As a result, the slurry and carrier material 2 are heated directly. The parameters of the inductors 6, for example, electric current or frequency, can be adapted to the desired temperature.

The foil material 1 is conveyed through the device 5 in the conveying direction 8 and dried by a first alternating electromagnetic field 9 in the process. The foil material 1 is conveyed contactlessly through the device 5 by a second alternating electromagnetic field 11 generated by inductors 6.

The inductors 6 are arranged on a first side 12 and an opposite second side 13 of the foil material 1.

The foil material 1 is conveyed in the conveying direction 8 through the device 5 and the inductors 6 are used to generate a temperature gradient in the foil material 1 in a first direction 14 extending transversely to the conveying direction 8. This allows different temperatures to be generated in the foil material 1 along the width of the foil material 1.

The device 5 comprises a multiplicity of inductors 6 which are operable independently of one another such that temperature fields that differ from one another, in this case a first temperature field 15 and, following this, a second temperature field 16, can be generated, for example, in the conveying direction 8, or else transversely thereto.

Tears and/or pores 17 can be generated in the coating 3 by way of a controlled heating of the coating 3, the tears and/or pores starting from a surface 24 of the coating 3 and extending to the carrier material 2. A targeted adaptation of a temperature field 15, 16 can be used to, e.g., introduce tears and/or pores 17 into the electrode material or the coating 3 in a targeted manner at some points of the foil material 1 such that the electrolyte of the battery cell can penetrate deeper into the electrode material or into the coating 3.

At least some of the constituents 4 of the coating 3 can be magnetized by an inductor 6. These magnetized constituents 4 can be demagnetized again by an undirected third alternating electromagnetic field 18 that is disposed downstream in a conveying direction 8. The ferromagnetic constituents 4 of the active material of the coating 3, for example, can be magnetized by the induced alternating electromagnetic fields 9, 11. The ferromagnetic constituents 4 can be demagnetized again by way of an undirected third alternating electromagnetic field 18 at the end of the drying or the device 5.

FIG. 4 shows a first disclosed embodiment of an inductor 6 in a perspective view. The inductor 6 is embodied as a so-called longitudinal field inductor. Here, the inductor 6 or the coil turns of the inductor 6 extend(s) around the foil material 1, each coil turn extending transversely to the conveying direction 8. The alternating field 9, 11, 18 generated thus extends substantially parallel to the conveying direction 8 on each side 12, 13 of the foil material 1. The direction of the current 23 generated in the foil material 1 is illustrated in the magnified excerpt of the foil material 1.

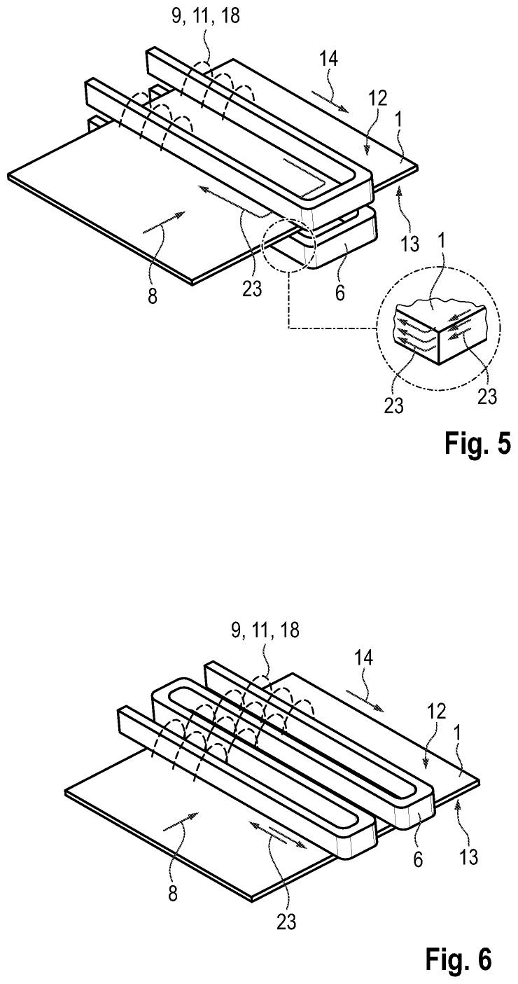

FIG. 5 shows a second disclosed embodiment of an inductor 6 in a perspective view. The inductor 6 is embodied as a so-called transverse field inductor. Here, the inductor 6 or the coil turns of the inductor 6 extend(s) on both sides of the foil material 1, each coil turn extending over the foil material 1 along the width of the foil material 1, i.e., transversely to the conveying direction 8. The alternating field 9, 11, 18 generated thus extends through the foil material 1 along the thickness of the foil material 1. The direction of the current 23 generated in the foil material 1 is illustrated in the magnified excerpt of the foil material 1.

FIG. 6 shows a third disclosed embodiment of an inductor 6 in a perspective view. The inductor 6 is embodied as a so-called surface inductor. Here, the inductor 6 or a turn extends in a meandering state on one side 12, 13 of the foil material 1, in each case over the foil material 1 along the width of the foil material 1, i.e., transversely to the conveying direction 8. The alternating field 9, 11, 18 generated thus in each case extends transversely to the extent of the turn on each side 12, 13 of the foil material 1. The direction of the current 23 generated in the foil material 1 is illustrated in the magnified excerpt of the foil material 1 in relation to FIG. 5.

### LIST OF REFERENCE SIGNS

1 Foil material
2 Carrier material
3 Coating
4 Constituent
5 Device
6 Inductor
7 Relative movement
8 Conveying direction
9 First alternating field
10 Gas flow
11 Second alternating field
12 First side
13 Second side
14 First direction
15 First temperature field
16 Second temperature field
17 Tear
18 Third alternating field
19 Tension roller
20 Extraction
21 Rolling device
22 Guide rolls
23 Current
24 Surface

1. A device for drying a foil material that includes a strip-shaped carrier material with a coating arranged thereon, the coating including electrically conductive constituents, the device comprising at least one inductor for drying the coating by electromagnetic induction.

2. The device of claim 1, wherein a relative movement is generated between the foil material and the device during the heating the foil material by electromagnetic induction.

3. The method of claim 2, wherein the foil material is conveyed through the device at least in one conveying direction and is dried by at least one first alternating electromagnetic field, wherein the foil material is conveyed contactlessly through the device at least by a gas flow or by a second alternating electromagnetic field.

4. The device of claim 1, wherein the at least one inductor is arranged only on one side of the foil material or on a first side and an opposite second side of the foil material.

5. The device of claim 1, wherein the at least one inductor is operated such that the coating and the carrier material are heated differently from one another.

6. The device of claim 1, wherein the foil material is conveyed at least in one conveying direction through the device and wherein the at least one inductor is used to generate a temperature gradient in the foil material in a first direction extending transversely to the conveying direction or in the conveying direction.

7. The device of claim 1, wherein the device comprises a plurality of inductors which are operable independently of one another such that temperature fields that differ from one another are generated for heating purposes.

8. The device of claim 1, wherein tears and/or pores are generated in the coating by a controlled heating of the coating, the tears and/or pores starting from a surface of the coating and at least extending to the carrier material.

9. The device of claim 1, wherein at least some of the constituents of the coating are magnetized by the at least one inductor and these magnetized constituents are demagnetized by a non-directed third alternating electromagnetic field disposed downstream in a conveying direction.

10. The device of claim 1, wherein the carrier material is an at least partly electrically conductive conductor foil and the coating is a slurry, wherein the slurry comprises at least an active material, a conductive carbon black, a binder and a solvent.

11. The device of claim 10, wherein the at least one inductor brings about a targeted spatial alignment of at least the conductive carbon black present in the slurry as particles or fibers.

12. A method for drying a foil material that includes a strip-shaped carrier material with at least one coating arranged thereon, the coating including electrically conductive constituents, the method comprising:
providing the foil material;
providing a device for drying the coating, wherein the device includes at least one inductor; and
drying the coating by heating the foil material by electromagnetic induction.

13. The method of claim 12, wherein a relative movement is generated between the foil material and the device during the heating the foil material by electromagnetic induction.

14. The method of claim 13, wherein the foil material is conveyed through the device at least in one conveying direction and is dried by at least one first alternating electromagnetic field, wherein the foil material is conveyed contactles sly through the device at least by a gas flow or by a second alternating electromagnetic field.

15. The method of claim 12, wherein the at least one inductor is arranged only on one side of the foil material or on a first side and an opposite second side of the foil material.

16. The method of claim 12, wherein the at least one inductor is operated such that the coating and the carrier material are heated differently from one another.

17. The method of claim 12, wherein the foil material is conveyed at least in one conveying direction through the device and wherein the at least one inductor is used to generate a temperature gradient in the foil material in a first direction extending transversely to the conveying direction or in the conveying direction.

18. The method of claim 12, wherein the device comprises a plurality of inductors which are operable independently of one another such that temperature fields that differ from one another are generated for heating purposes.

19. The method of claim 12, wherein tears and/or pores are generated in the coating by a controlled heating of the coating, the tears and/or pores starting from a surface of the coating and at least extending to the carrier material.

20. The method of claim 12, wherein at least some of the constituents of the coating are magnetized by the at least one inductor and these magnetized constituents are demagnetized by a non-directed third alternating electromagnetic field disposed downstream in a conveying direction.

21. The method of claim 12, wherein the carrier material is an at least partly electrically conductive conductor foil and the coating is a slurry, wherein the slurry comprises at least an active material, a conductive carbon black, a binder and a solvent.

22. The method of claim 11, wherein the at least one inductor brings about a targeted spatial alignment of at least the conductive carbon black present in the slurry as particles or fibers.
